(19) United States
(12) Patent Application Publication
(10) Pub. No.: US 2017/0154135 A1
(43) Pub. Date: Jun. 1, 2017

(54) SYSTEM AND METHOD FOR VALIDATING DAMPING MATERIAL DYNAMIC PROPERTY

(71) Applicants: Inventec (Pudong) Technology Corporation, Shanghai (CN); INVENTEC CORPORATION, Taipei City (TW)

(72) Inventors: Yu-Hsien HUANG, Taipei City (TW); Wen-Hua CHEN, Taipei City (TW); Hsieh-Liang TSAI, Taipei City (TW)

(21) Appl. No.: 15/079,667

(22) Filed: Mar. 24, 2016

(30) Foreign Application Priority Data
Nov. 26, 2015 (CN) 2015108372223

(51) Int. Cl. G06F 17/50; G06F 17/12; G01M 7/02

(52) U.S. Cl. CPC G06F 17/5009; G01M 7/022; G01M 7/025; G06F 17/12; G11B 33/14

(57) ABSTRACT

A system and a method for validating damping material dynamic property are provided. In the method, a measured platform is established by a viscoelastic material firstly, and then obtains a measured frequency response data. Following up, establish a viscoelastic model for a viscoelastic material, and than derived the viscoelastic function based viscoelastic model. Then, the viscoelastic function is substitute into a dynamic load equation; further obtains a simulation storage modulus and a simulation loss modulus. Then, obtain a simulation frequency response data by the simulation elastic modulus and the simulation viscosity coefficient. Next, obtain the integrated frequency response data according to the reference temperature with an algorithm. Finally, calculating out an elastic modulus value and the viscosity coefficient value by the integrated frequency response data.

### BACKGROUND OF INVENTION

1. Field of the Invention

The present invention is related to a system for validating damping material dynamic property and a method thereof, and more particularly related to a system, which measures damping material property and computing material coefficient for validating damping material dynamic property, and a method thereof.

2. Description of the Prior Art

A slim size and portable design is the trend of current electronic industry but facing the challenge of structural strength and shock-resistant capability. Thus, it is required to use the damping material to absorb vibration energy or reduce impact force applied to the falling device.

In the server industry, because the vibration occurred during operation of high-speed fans may affect read performance of hard disk drives to result in the decreasing of data transfer rate or even the read failure. Thus, it is common to have the damping material interposed between the fans and the case of the server to isolate the vibration or use a layer of damping material as a cover mounted on the case of the hard disk drive.

Because damping material processes both elasticity and viscosity, it is required to use viscoelastic theory when analyzing its behavior. That is, the damping material is regarded as a viscoelastic material, which stores a portion of the energy by elastic deformation and dissipates a portion of the energy by heat when suffering a periodic external force. These energies can be represented by the complex modulus of the damping material, i.e. the storage modulus and the loss modulus.

It is common to use a dynamic mechanical analysis (DMA) instrument to measure the dynamic mechanical properties of the material so as to access the storage modulus and the loss modulus. However, such machine is quite expensive and would be an unwanted burden for the companies other than the developing companies of the damping material.

### SUMMARY OF THE INVENTION

It is common in the electronic industry to use the damping material for absorbing vibration energy or reducing the impact force applied to the falling device to protect the electronic devices such as the hard disk drive. Thus, it is relatively important to analyze the properties of the damping material. However, the conventional art needs the dynamic mechanical analysis (DMA) instrument to measure the dynamic mechanical properties of the damping material for accessing the storage modulus and the loss modulus, and the DMA instrument is quite expensive and difficult to access. Accordingly, it is a main object of the present invention to provide a method for validating damping material dynamic property, which measures and simulates the frequency response data to generate the integrated frequency response data for the user to calculate the dynamic mechanical properties of the damping material.

As mentioned, in accordance with the object of the present invention, a method for validating damping material dynamic property is provided. The method comprises the steps of: (a) establishing a measured platform by using a viscoelastic material, and vibrating the measured platform under at least one reference temperature to obtain a measured frequency response data corresponding to the reference temperature and the viscoelastic material; (b) establishing a viscoelastic model based on viscoelastic properties of the viscoelastic material, and the viscoelastic model including at least one elastic element and at least one viscous element; (c) establishing a constitutive equation corresponding to the viscoelastic model and deriving a viscoelastic function including at least one elastic modulus (E) and at least one coefficient of viscosity (η) from the constitutive equation, wherein the elastic modulus corresponds to the elastic element and the coefficient of viscosity corresponds to the viscous element; (d) substituting the viscoelastic function into a dynamic load equation with a frequency coefficient to obtain a simulation storage modulus (Y1) and a simulation loss modulus (Y2) such that the simulation storage modulus (Y1) and the simulation loss modulus (Y2) are decided by the elastic modulus, the coefficient of viscosity, and the frequency coefficient; (e) obtaining a simulation frequency response data based on the simulation storage modulus and the simulation loss modulus by using a finite element method; (f) obtaining an integrated frequency response data corresponding to the reference temperature by using the simulation frequency response data to approximate the measured frequency response data using an algorithm, and the integrated frequency response data including an optimized elastic modulus and an optimized coefficient of viscosity; and (g) substituting the optimized elastic modulus and the optimized coefficient of viscosity into the simulation storage modulus and the simulation loss modulus to calculate a storage modulus value and a loss modulus value corresponding to the elastic material under the reference temperature.

In accordance with an embodiment of the present invention, the measured platform comprises a base and two clamps, and the two clamps are locked on the base for clamping a viscoelastic element composed of the viscoelastic material. As a preferred embodiment, the viscoelastic element is composed of the viscoelastic material located on two sides of a mass block, and the two clamps clamp the viscoelastic material on the two sides of the mass block respectively.

In accordance with an embodiment of the present invention, step (a) is executed by using a vibrator to vibrate the measured platform. As a preferred embodiment, the vibrator vibrates the measured platform according to a vibration frequency value and step (g) further comprises substituting the vibration frequency value into the simulation storage modulus and the simulation loss modulus.

In accordance with the object of the present invention, a system for validating damping material dynamic property is also provided. The system comprises a measured platform, a mass block, two pieces of viscoelastic material, a vibrator, a first accelerator, at least a second accelerator, and a system host. The measured platform comprises a base and two clamps symmetrically locked on the base. The mass block is located between the two clamps. The two pieces of viscoelastic material are affixed to the two clamps and touch two corresponding sides of the mass block respectively for lifting the mass block between the two clamps. The vibrator is utilized for vibrating the measured platform. The first accelerator is attached to the mass block. The second accelerator is attached to at least one of the two clamps.

The system host is electrically connected to the first accelerator and the second accelerator. When the vibrator vibrates under a reference temperature, the system host obtains a measured frequency response data corresponding to the reference temperature and the viscoelastic material by measuring through the first accelerator and the second accelerator. Then, the system host obtains an integrated frequency response data corresponding to the reference temperature by using a simulation frequency response data and the measured frequency response data using an algorithm. The integrated frequency response data includes an optimized elastic modulus and an optimized coefficient of viscosity, and the system host further substitutes the optimized elastic modulus and the optimized coefficient of viscosity into a simulation storage modulus and a simulation loss modulus to calculate a storage modulus value and a loss modulus value corresponding to the elastic material under the reference temperature.

In accordance with an embodiment of the present invention, each of the two clamps includes a clamping part, and the mass block and the two pieces of the viscoelastic material are fixed between the two clamping parts.

In accordance with an embodiment of the present invention, the system host obtains the simulation frequency response data based on the simulation storage modulus and the simulation loss modulus by using a finite element method. As a preferred embodiment, the simulation storage modulus corresponds to at least one elastic element of a viscoelastic model established based on viscoelastic properties of the viscoelastic material, and the simulation loss modulus corresponds to at least one viscous element of a viscoelastic model established based on viscoelastic properties of the viscoelastic material.

As mentioned, in accordance with the technology provided in the present invention, the simulation storage modulus (Y1) and the simulation loss modulus (Y2) for a specific viscoelastic material is computed. Thus, for the any other viscoelastic elements made of the viscoelastic material, after placing the viscoelastic element on the measured platform, the integrated frequency response data can be derived from the simulation storage modulus (Y1) and the simulation loss modulus (Y2) by using the finite element method directly. Thereby, the user can access the viscoelastic property under the reference temperature and the frequency coefficient without the need to execute additional measurement or experiment.

### BRIEF DESCRIPTION OF THE DRAWINGS

The present invention will now be specified with reference to its preferred embodiment illustrated in the drawings, in which:

FIG. 1 and FIG. 1A are flow charts showing the method for validating damping material dynamic property in accordance with a preferred embodiment of the present invention;

FIG. 2 is a top view showing the system for validating damping material dynamic property in accordance with a preferred embodiment of the present invention; and

FIG. 3 and FIG. 4 are diagrams showing the comparison of frequency response data under a reference temperature of 60° C.

### DESCRIPTION OF THE PREFERRED EMBODIMENT

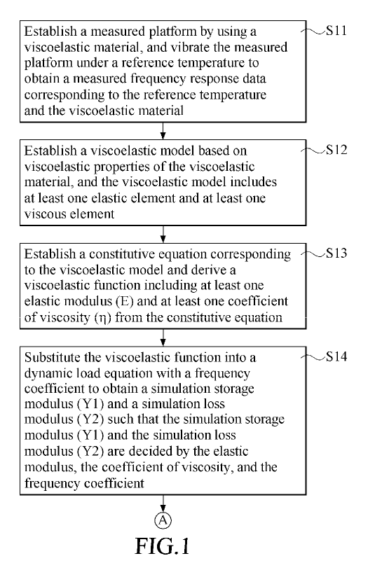

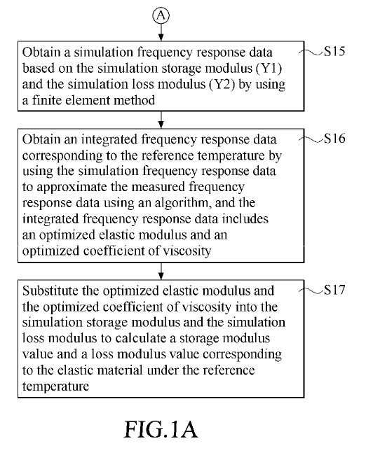

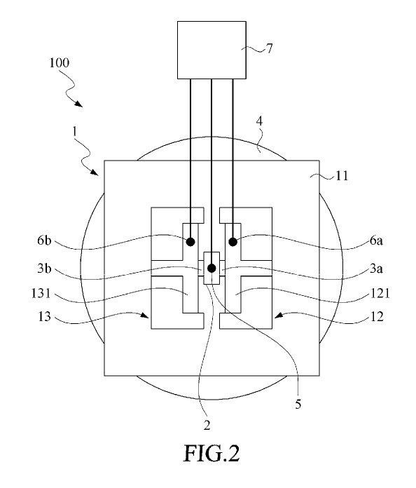

Please refer to FIG. 1 to FIG. 2, wherein FIG. 1 and FIG. 1A are flow charts showing the method for validating damping material dynamic property in accordance with a preferred embodiment of the present invention, and FIG. 2 is a top view showing the system for validating damping material dynamic property in accordance with a preferred embodiment of the present invention. As shown, a system 100 for validating damping material dynamic property comprises a measured platform 1, a mass block 2, two pieces of viscoelastic material 3a and 3b, a vibrator 4, a first accelerator 5, two second accelerators 6a and 6b, and a system host 7. The measured platform 1 comprises a base 11 and two clamps 12 and 13 symmetrically locked on the base 11. Each of the two clamps 12 and 13 includes a clamping part 121, 131, respectively. The mass block 2 is located between the two clamps 12 and 13.

The two pieces of viscoelastic material 3a and 3b are affixed to the two clamps 12 and 13 and touch the two corresponding sides of the mass block 2 respectively for lifting the mass block 2 between the two clamps 12 and 13. As a preferred embodiment, the two pieces of viscoelastic material 3a and 3b are made of the same viscoelastic material.

The vibrator 4 has a space for assembling the measured platform 1 and is utilized for vibrating the measured platform 1. The first accelerator 5 is attached to the mass block 2. The second accelerators 6a and 6b are attached to the two clamps 12 and 13.

The system host 7 is electrically connected to the first accelerator 5 and the second accelerators 6a and 6b. When the vibrator 4 vibrates under a reference temperature, the system host 7 obtains a measured frequency response data corresponding to the reference temperature and the viscoelastic material by measuring through the first accelerator 5 and the second accelerators 6a and 6b. Then, the system host 7 obtains an integrated frequency response data corresponding to the reference temperature by using a simulation frequency response data and the measured frequency response data using an algorithm. The integrated frequency response data includes an optimized elastic modulus and an optimized coefficient of viscosity, and the system host 7 further substitutes the optimized elastic modulus and the optimized coefficient of viscosity into a simulation storage modulus and a simulation loss modulus to calculate a storage modulus value and a loss modulus value corresponding to the elastic material under the reference temperature.

As mentioned, by using the system 100 for validating damping material dynamic property provided in the present invention, a method for validating damping material dynamic property is provided in accordance with a preferred embodiment of the present invention. First, the step S11 is carried out to establish a measured platform 1 by using a viscoelastic material (corresponding to the two pieces of viscoelastic material 3a and 3b), and then vibrate the measured platform 1 under a reference temperature to obtain a measured frequency response data corresponding to the reference temperature and the viscoelastic material.

In practice, when assembling the measured platform 1 to the vibrator 4, firstly, two pieces of damping material 3a and 3b are affixed to the two sides of the mass block 2, then the clamping parts 121 and 131 of the clamps 12 and 13 are used to clamp the damping material and lift the mass block 2, thereafter, the two clamps 12 and 13 are locked on the base 11, and finally, the base 11 is locked on the vibrator 4. The two pieces of damping material 3a and 3b may be made of the same viscoelastic material.

After assembling the measured platform 1 to the vibrator 4, the vibrator 4 is started and the vibration energy is transferred from the vibrator 4, through the clamps 12 and 13, to the mass block 2. The two pieces of damping material 3a and 3b may absorb part of the vibration energy such that the frequency response data of the mass block 2 would be different from the vibration waveform generated by the vibrator 4, and the whole measured platform 1 operates as a single degree of freedom system.

Then, the accelerators are attached to the mass block 2 and the clamps 12 and 13 for measuring the measured frequency response data corresponding to the mass block 2. The measured frequency response data includes frequency response and phase.

Thereafter, step S12 is carried out to establish a viscoelastic model based on viscoelastic properties of the viscoelastic material, and the viscoelastic model includes at least one elastic element and at least one viscous element. In the present embodiment, the base 11 may be regarded as serially connected to the clamps 12 and 13 and the viscoelastic element composed of the two pieces of viscoelastic material 3a and 3b and the mass block 2, and the clamps 12 and 13 may be regarded as parallel connected to the mass block 2.

Creep and stress relaxation are the major mechanical properties of viscoelastic material, and are also the two basic tests for viscoelastic material researches. As a stress is applied to the viscoelastic material, the material may have the phenomena of creep and stress relaxation, both of which are time dependent. That is, the stress-strain curve of the viscoelastic material is a time dependent function.

The viscoelastic material can be modeled as a combination of a spring and a damper. The spring is an ideal linear spring, which has an instantaneous strain when a stress is applied, has a linear relationship between stress and strain, and the stress/strain is not varied with time. The constitutive equation of the spring can be represented by the following function (1), where E is the elastic Modulus.

σ=E×ε (1)

The damper portion follows the Newton's law of viscosity as shown in the following function (2), where η is the coefficient of viscosity, ε′ is the first order derivative of strain with respect to time, i.e. the strain rate.

σ=η×ε′ (2)

The viscoelastic model can be represented by a spring and a damper connected in series or in parallel. In the other embodiments, the viscoelastic model can be Maxwell model, Kelvin model, Burgers model, or the other typical viscoelastic models.

Thereafter, step S13 is carried to establish a constitutive equation corresponding to the viscoelastic model and derive a viscoelastic function including at least one elastic modulus (E) and at least one coefficient of viscosity (η) from the constitutive equation, wherein the elastic modulus (E) corresponds to the elastic element and the coefficient of viscosity (η) corresponds to the viscous element. In the present embodiment, the constitutive equation is derived as the following function (3).

σ+p1×σ′+p2×σ″=q0×ε+q1×ε′+q2×ε″ (3)

Then, the constitutive equation is derived as the following viscoelastic function.

$$\begin{matrix}p 1 = \frac{E 1 η 3 + E 2 η 3 + E 3 η 3 + E 3 η 4}{( E 1 + E 2 ) E 3} & ( 4 ) \\ p 2 = \frac{η2η3}{( E 1 + E 2 ) E 3} & ( 5 ) \\ q 0 = \frac{E 1 E 2}{( E 1 + E 2 )} & ( 6 ) \\ q 1 = \frac{E 1 ( E 2 η 3 + E 3 η 3 + E 3 η 4 )}{( E 1 + E 2 ) E 3} & ( 7 ) \\ q 2 = \frac{E 1 η 3 η 4 )}{( E 1 + E 2 ) E 3} & ( 8 )\end{matrix}$$

Then, the step S14 is carried out to substitute the viscoelastic function into a dynamic load equation with a frequency coefficient to obtain a simulation storage modulus (Y1) and a simulation loss modulus (Y2) such that the simulation storage modulus (Y1) and the simulation loss modulus (Y2) are decided by the elastic modulus, the coefficient of viscosity, and the frequency coefficient.

As mentioned above, the dynamic load equation is represented as below.

$$\begin{matrix}{Y}^{*} ( i ω ) = \frac{{P}^{*} ( i ω )}{{Q}^{*} ( i ω )} \\ = \frac{{q}_{0} + {q}_{1} ( i ω ) + {{q}_{2} ( i ω )}^{2}}{1 + {p}_{1} ( i ω ) + {{p}_{2} ( i ω )}^{2}} \\ = {Y}_{1} ( i ω ) + {iY}_{2} ( ω )\end{matrix} \qquad ( 9 )$$

Then, P* and Q* in the function (3) are substituted by pk and qk, and the real part and the imaginary part of the function are separated to obtain the simulation storage modulus (Y1) and the simulation loss modulus (Y2) as below.

$$\begin{matrix}{Y}_{1} ( ω ) = \frac{{q}_{0} + ( {p}_{1} {q}_{1} - {p}_{2} {q}_{2} - {q}_{2} ) {ω}^{2} + {p}_{2} {q}_{2} {ω}^{4}}{{p}_{1}^{2} {ω}^{2} + {( 1 - {p}_{2} {ω}^{2} )}^{2}} & ( 10 ) \\ {Y}_{2} ( ω ) = \frac{( {q}_{1} + {p}_{1} {q}_{0} ) + ( {p}_{1} {q}_{2} - {q}_{2} {q}_{1} ) {ω}^{3}}{{p}_{1}^{2} {ω}^{2} + {( 1 - {p}_{2} {ω}^{2} )}^{2}} & ( 11 )\end{matrix}$$

Finally, the terms in the functions (11), such as the functions pk and qk, can be substituted by the functions (4) to (8). Thus, the simulation storage modulus (Y1) and the simulation loss modulus (Y2) are decided by the modeling parameters (E1 [symbol] E2 [symbol] E3 [symbol] η3 [symbol] η4) and the frequency coefficient (ω).

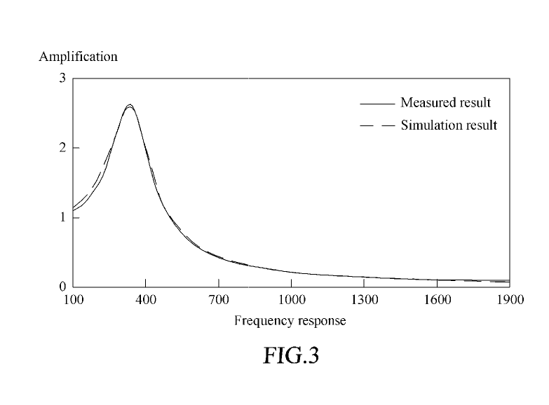

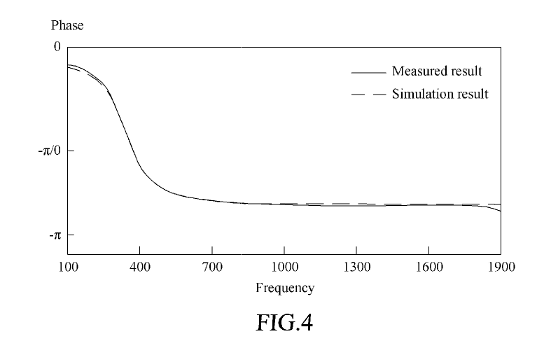

Please also refer to diagrams in FIG. 3 and FIG. 4, which illustrate the comparison of frequency response data under a reference temperature of 60° C. As shown, the subsequent step S15 is carried out to obtain a simulation frequency response data based on the simulation storage modulus (Y1) and the simulation loss modulus (Y2) by using a finite element method. Wherein, the integrated frequency response data including an optimized elastic modulus and an optimized coefficient of viscosity. In the present embodiment, the finite element analysis solver, MSC. Nastran, is used to find the solution by using a direct frequency response (Sol 108) analysis. In order to improve the calculation speed, the calculation is carried out by using a full finite element model, and then a equivalent model includes a mass dot and a 1D Bush element is establish for the finite element model. Then, the calculated simulation storage modulus (Y1) and the simulation loss modulus (Y2) are inputted to represent the material property, and the load condition of 1 unit acceleration at the grounded end is applied to the model.

Then, the acceleration of the mass dot is accessed in the after operation as the simulation frequency response data.

Thereafter, step S16 is carried out to obtain an integrated frequency response data corresponding to the reference temperature by using the simulation frequency response data to approximate the measured frequency response data using an algorithm.

Finally, step S17 is carried out to substitute the optimized elastic modulus and the optimized coefficient of viscosity into the simulation storage modulus (Y1) and the simulation loss modulus (Y2) to calculate a storage modulus value and a loss modulus value corresponding to the elastic material under the reference temperature.

As mentioned above, the present embodiment compares the simulation frequency response date obtained in the simulation and the measured frequency response date obtained by experiment, and has the simulation frequency response curve corresponding to the simulation frequency response data gradually approximate the measured frequency response curve corresponding to the measured frequency response data using an algorithm so as to obtain the integrated frequency response data including an optimized elastic modulus (E0) and an optimized coefficient of viscosity (η0) under the reference temperature (e.g. 60° C. in the present embodiment). Thus, for a given viscoelastic material, the user can obtain the frequency response relationship from the integrated frequency response data directly without the need to do the measurement.

In addition, the user may further obtain the modeling parameters such as elastic modulus value and the coefficient of viscosity value under different temperatures by using the method provided in the present invention as shown in the following table.

TABLE 1

| | |
|---|---|
| | coefficient |
| elastic | of viscosity |
| modulus value | value |

| | | | | |
|---|---|---|---|---|
| E₁ | E₂ | E₃ | η₃ | η₄ |

| | |
|---|---|
| Unit: 10⁶ × N/mm² | Unit: N × s/mm² |

| | | | | | |
|---|---|---|---|---|---|
| 30° C. | 74.3 | 2.38 | 9.46 | 2990 | 4720 |
| 40° C. | 24.4 | 1.87 | 2.23 | 904 | 2560 |
| 50° C. | 13.1 | 58.5 × 10⁻⁶ | 3.09 | 1552 | 1220 |
| 60° C. | 8.37 | 68.2 × 10⁻³ | 2.59 | 1230 | 768 |

In conclusion, in compared with the costly solution of the conventional art, which uses the dynamic mechanical analysis (DMA) instrument to measure the dynamic mechanical properties of the damping material, the present invention measures the measured platform with the viscoelastic material to obtain the measured frequency response data, establishes the viscoelastic modeling function for the viscoelastic material, and uses the obtained simulation storage modulus and the simulation loss modulus to obtain the simulation frequency response data by using the finite element method. The simulation frequency response data is them compared with the measured frequency response data to obtain the modeling parameters such as the elastic modulus and the coefficient of viscosity under the reference temperature. Thereby, after the integrated frequency response data is obtained by using the method provided in the present invention, the user just needs to compare the measured frequency response data and the simulation frequency response data under different reference temperature to compute the integrated frequency response data corresponding to the specific reference temperature so as to obtain the modeling parameters (i.e. elastic modulus value and coefficient of viscosity value) under the certain reference temperature to save the cost and the time.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A method for validating damping material dynamic property, comprising the steps of:
(a) establishing a measured platform by using a viscoelastic material, and vibrating the measured platform under at least one reference temperature to obtain a measured frequency response data corresponding to the reference temperature and the viscoelastic material;
(b) establishing a viscoelastic model based on viscoelastic properties of the viscoelastic material, and the viscoelastic model including at least one elastic element and at least one viscous element;
(c) establishing a constitutive equation corresponding to the viscoelastic model and deriving a viscoelastic function including at least one elastic modulus (E) and at least one coefficient of viscosity (η) from the constitutive equation, wherein the elastic modulus corresponds to the elastic element and the coefficient of viscosity corresponds to the viscous element;
(d) substituting the viscoelastic function into a dynamic load equation with a frequency coefficient to obtain a simulation storage modulus (Y1) and a simulation loss modulus (Y2) such that the simulation storage modulus (Y1) and the simulation loss modulus (Y2) are decided by the elastic modulus, the coefficient of viscosity, and the frequency coefficient;
(e) obtaining a simulation frequency response data based on the simulation storage modulus and the simulation loss modulus by using a finite element method;
(f) obtaining an integrated frequency response data corresponding to the reference temperature by using the simulation frequency response data to approximate the measured frequency response data using an algorithm, and the integrated frequency response data including an optimized elastic modulus and an optimized coefficient of viscosity; and
(g) substituting the optimized elastic modulus and the optimized coefficient of viscosity into the simulation storage modulus and the simulation loss modulus to calculate a storage modulus value and a loss modulus value corresponding to the elastic material under the reference temperature.

2. The method for validating damping material dynamic property of claim 1, wherein the measured platform comprises a base and two clamps, and the two clamps are locked on the base for clamping a viscoelastic element composed of the viscoelastic material.

3. The method for validating damping material dynamic property of claim 2, wherein the viscoelastic element is composed of the viscoelastic material located on two sides of a mass block, and the two clamps clamp the viscoelastic material on the two sides of the mass block respectively.

4. The method for validating damping material dynamic property of claim 1, wherein the step (a) is executed by using a vibrator to vibrate the measured platform.

5. The method for validating damping material dynamic property of claim 4, wherein the vibrator vibrates the measured platform according to a vibration frequency value and the step (g) further comprises substituting the vibration frequency value into the simulation storage modulus and the simulation loss modulus.

6. A system for validating damping material dynamic property comprising:
a measured platform comprising:
a base; and
two clamps, symmetrically locked on the base;
a mass block located between the two clamps;
two pieces of a viscoelastic material, affixed to the two clamps and touching two corresponding sides of the mass block respectively for lifting the mass block between the two clamps;
a vibrator, for vibrating the measured platform;
a first accelerator, attached to the mass block;
at least one second accelerator, attached to at least one of the two clamps; and
a system host, electrically connected to the first accelerator and the second accelerator, when the vibrator vibrates under a reference temperature, the system host obtaining a measured frequency response data corresponding to the reference temperature and the viscoelastic material by measuring through the first accelerator and the second accelerator and further obtaining an integrated frequency response data corresponding to the reference temperature by using a simulation frequency response data and the measured frequency response data using an algorithm, and the integrated frequency response data including an optimized elastic modulus and an optimized coefficient of viscosity, and the system host further substituting the optimized elastic modulus and the optimized coefficient of viscosity into a simulation storage modulus and a simulation loss modulus to calculate a storage modulus value and a loss modulus value corresponding to the elastic material under the reference temperature.

7. The system for validating damping material dynamic property of claim 6, wherein each of the two clamps includes a clamping part, and the mass block and the two pieces of the viscoelastic material are fixed between the two clamping parts.

8. The system for validating damping material dynamic property of claim 6, wherein the system host obtains the simulation frequency response data based on the simulation storage modulus and the simulation loss modulus by using a finite element method.

9. The system for validating damping material dynamic property of claim 8, wherein the simulation storage modulus corresponds to at least one elastic element of a viscoelastic model established based on viscoelastic properties of the viscoelastic material.

10. The system for validating damping material dynamic property of claim 8, wherein the simulation loss modulus corresponds to at least one viscous element of a viscoelastic model established based on viscoelastic properties of the viscoelastic material.
